(19) United States
(12) Patent Application Publication
(10) Pub. No.: US 2026/0103770 A1
(43) Pub. Date: Apr. 16, 2026

(54) CONTINUOUS HEATING APPARATUS

(71) Applicant: TOYOTA JIDOSHA KABUSHIKI KAISHA, Aichi-ken (JP)

(72) Inventors: Yutaka YOSHIDA, Anjo-shi (JP); Suguru MATSUOKA, Nagoya-shi (JP)

(21) Appl. No.: 19/330,832

(22) Filed: Sep. 17, 2025

(30) Foreign Application Priority Data
Oct. 16, 2024 (JP) 2024-181251

(51) Int. Cl. C21D 9/00; B21D 1/06; F27B 9/26

(52) U.S. Cl. CPC C21D 9/0006; B21D 1/06; F27B 9/26

(57) ABSTRACT

A continuous heating apparatus includes: a conveyance tray configured to place an object to be heated; a conveying mechanism configured to convey the conveyance tray; a blowing mechanism configured to blow hot air in a direction transverse to a conveyance direction of the conveyance tray; and a pair of first straightening plates provided at upstream and downstream ends of the conveyance tray in the conveyance direction of the conveyance tray.

The present application claims priority to and incorporates by reference the entire contents of Japanese Patent Application No. 2024-181251 filed in Japan on Oct. 16, 2024.

### BACKGROUND

1. Technical Field

The present disclosure relates to a continuous heating apparatus.

### 2. Related Art

JP 2012-097969 A discloses a heating furnace that performs heat treatment of an object to be heated (for example, a brazed component) by blowing hot air in one direction.

### SUMMARY

In the brazing step, uniformity is required in a temperature range of several degrees Celsius. In particular, in a large-sized component such as a cooler in a battery of an electric vehicle, a volume of a heating furnace for performing heat treatment also increases, and therefore, unevenness occurs in a flow rate and a temperature of hot air applied to the component. Further, when a continuous furnace is used instead of a batch furnace, the problem of unevenness in the flow rate and temperature of hot air becomes more remarkable.

It is desirable to provide a continuous heating apparatus capable of suppressing temperature unevenness during heat treatment of an object to be heated.

In some embodiments, a continuous heating apparatus includes: a conveyance tray configured to place an object to be heated; a conveying mechanism configured to convey the conveyance tray; a blowing mechanism configured to blow hot air in a direction transverse to a conveyance direction of the conveyance tray; and a pair of first straightening plates provided at upstream and downstream ends of the conveyance tray in the conveyance direction of the conveyance tray.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating a schematic configuration of a continuous heating apparatus according to an embodiment;

FIG. 2 is a plan view for explaining how hot air flows in the continuous heating apparatus according to the embodiment;

FIG. 3 is a plan view for explaining the flow of hot air in a general continuous heating apparatus;

FIG. 4 is a perspective view illustrating a configuration of a conveyance tray including front-rear straightening plates in the continuous heating apparatus according to the embodiment;

FIG. 5 is a side view illustrating the configuration of the conveyance tray including the front-rear straightening plates in the continuous heating apparatus according to the embodiment;

FIG. 6 is an enlarged view of part C of FIG. 5;

FIG. 7 is a perspective view illustrating a configuration of a conveyance tray including front-rear straightening plates and a central straightening plate in a continuous heating apparatus according to an embodiment;

FIG. 8 is a side view illustrating the configuration of the conveyance tray including the front-rear straightening plates and the central straightening plate in the continuous heating apparatus according to the embodiment; and

FIG. 9 is an enlarged view of a portion D of FIG. 8.

### DETAILED DESCRIPTION

A continuous heating apparatus according to an embodiment of the present disclosure will be described with reference to the drawings. Incidentally, the constituent elements in the following embodiments include those that can be easily replaced by a person skilled in the art or those that are substantially the same.

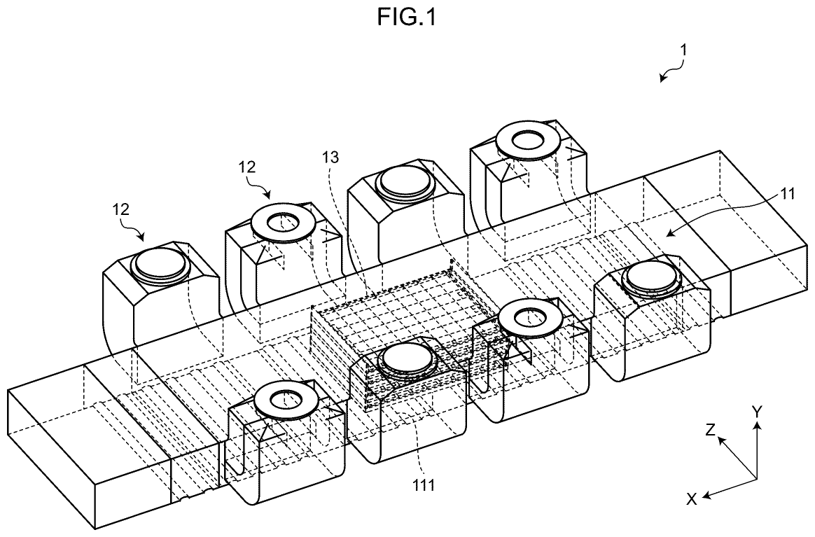

A configuration of the continuous heating apparatus according to the embodiment will be described with reference to FIGS. 1 to 3. The continuous heating apparatus according to the embodiment is an apparatus for heat-treating an object to be heated. Examples of the object to be heated (hereinafter, referred to as a workpiece W) include a brazed component such as a cooler used in a battery of an electric vehicle.

As illustrated in FIG. 1, the continuous heating apparatus 1 includes a conveyance mechanism 11, a plurality of blowing mechanisms 12, and a conveyance tray 13.

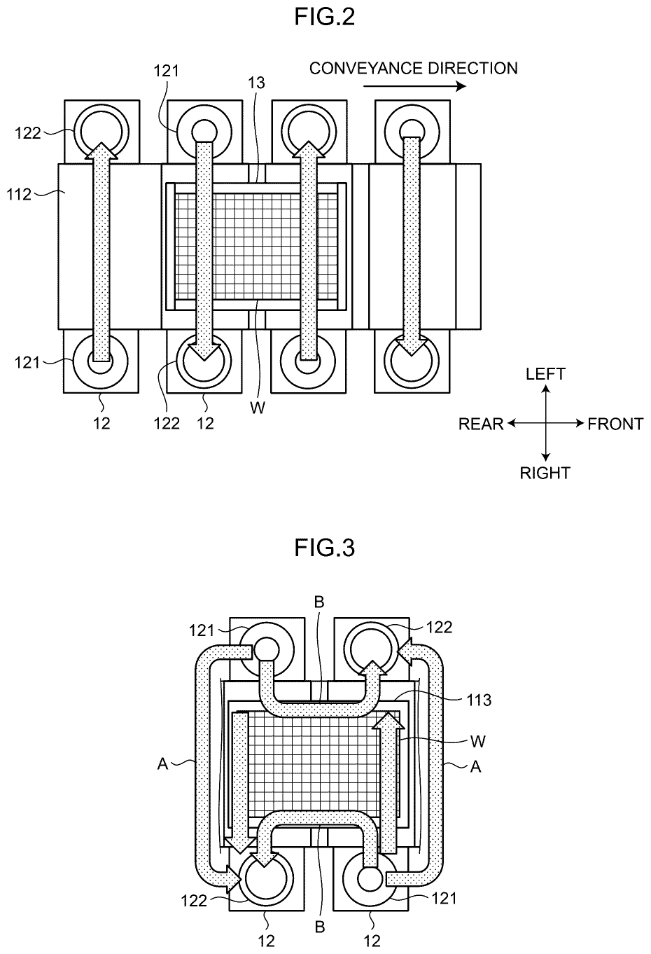

The conveyance mechanism 11 conveys the conveyance tray 13 while heating the conveyance tray 13. As illustrated in FIGS. 1 and 2, the conveyance mechanism 11 includes a conveyance roll 111 and a heating chamber 112.

The conveyance roll 111 conveys the conveyance tray 13 in a predetermined conveyance direction. The “conveyance direction” illustrated in FIG. 2 corresponds to a X direction in FIG. 1. The heating chamber 112 is a space in which the conveyance tray 13 is conveyed by the conveyance roll 111. Hot air is supplied to the heating chamber 112 from blowing ports 121 of the blowing mechanism 12. In the heating chamber 112, the workpiece W arranged in the conveyance tray 13 is conveyed while being heated by hot air.

As illustrated in FIG. 2, the blowing mechanism 12 ejects hot air from the left and right sides of the continuous heating apparatus to eject hot air in a direction transverse to the conveyance direction of the conveyance tray 13. As shown in FIG. 1, a plurality of blowing mechanisms 12 are arranged along the conveyance direction of the conveyance tray 13. Further, each of the blowing mechanisms 12 includes a blowing port 121 that ejects hot air into the heating chamber 112, and a suction port 122 that sucks hot air in the heating chamber 112.

As illustrated in FIG. 2, the blowing mechanisms 12 are arranged such that the blowing ports 121 and the suction ports 122 are alternately adjacent to each other in the conveyance direction of the conveyance tray 13. That is, the blowing mechanisms 12 are arranged such that the blowing ports 121 or the suction ports 122 are not adjacent to each other in the conveyance direction. As a result, each of the blowing mechanisms 12 ejects hot air toward the conveyance tray 13 from different directions during conveying the conveyance tray 13. Note that an arrow in FIG. 2 indicates the direction of hot air.

Although not shown in FIG. 1, a heating mechanism such as a heater for heating air is provided between the blowing mechanisms 12. Further, the blowing port 121 is provided with a push fan for supplying hot air heated by a heating mechanism into the heating chamber 112. Further, the suction port 122 is provided with a pull fan for drawing in hot air into the heating chamber 112.

Here, the cooler of the battery of the electric vehicle that is assumed as the workpiece W in the present embodiment is very large in size, and thus there is a possibility that the temperature unevenness is increased when the heat treatment in a general batch-type heating apparatus. Incidentally, although it is conceivable to lengthen the heating time of the workpiece W in order to suppress the temperature unevenness, it is not preferable from the viewpoint of mass productivity. Therefore, in the case of performing the heat treatment of the workpiece W having such a large size, in order to achieve both the suppression of temperature unevenness and mass productivity, as shown in FIG. 1, it is preferable to use a continuous heating apparatus 1 that sequentially injects hot air from different directions to the workpiece W during conveyance.

However, in a general continuous heating apparatus, when hot air is jetted from a different direction with respect to the workpiece W, it is not possible to realize hot air with an ideal flow direction. The hot air with the ideal flow direction, as shown in FIG. 2, for example, travels straight from the blowing port 121 to the suction port 122 and traverses the conveyance tray 113. In the general continuous heating apparatus, since the resistance (air resistance) when the hot air traverses the conveyance tray 113 is large, the flow of the hot air that avoids the conveyance tray 113 is generated, for example, as indicated by an arrow A in FIG. 3.

Further, since the resistance when the hot air traverses the conveyance tray 113 is large, a phenomenon occurs in which the hot air ejected from the blowing port 121 is sucked into the adjacent suction port 122, for example, as indicated by an arrow B in FIG. 3. Thus, in the conventional continuous heating apparatus, hot air does not directly hit the workpiece W, and it is difficult to efficiently heat the workpiece W.

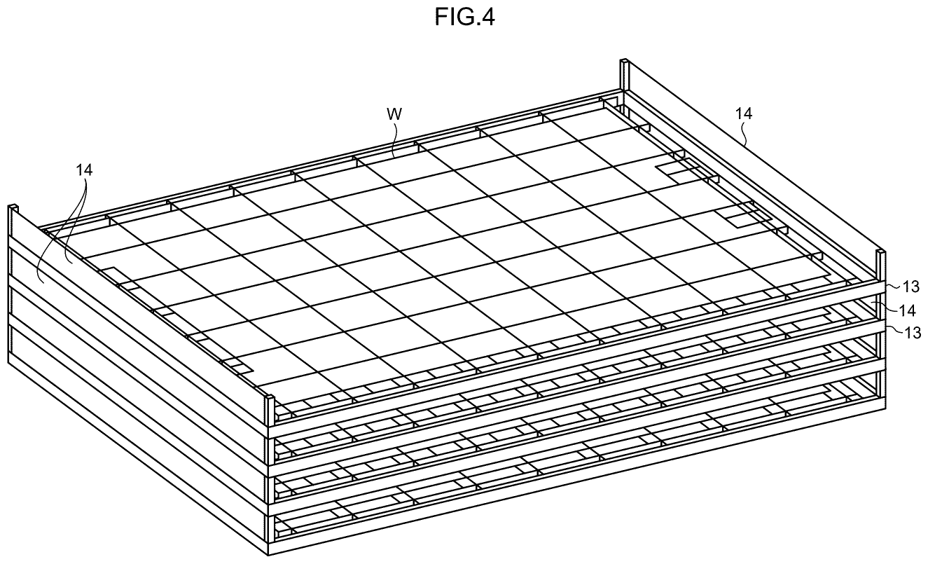

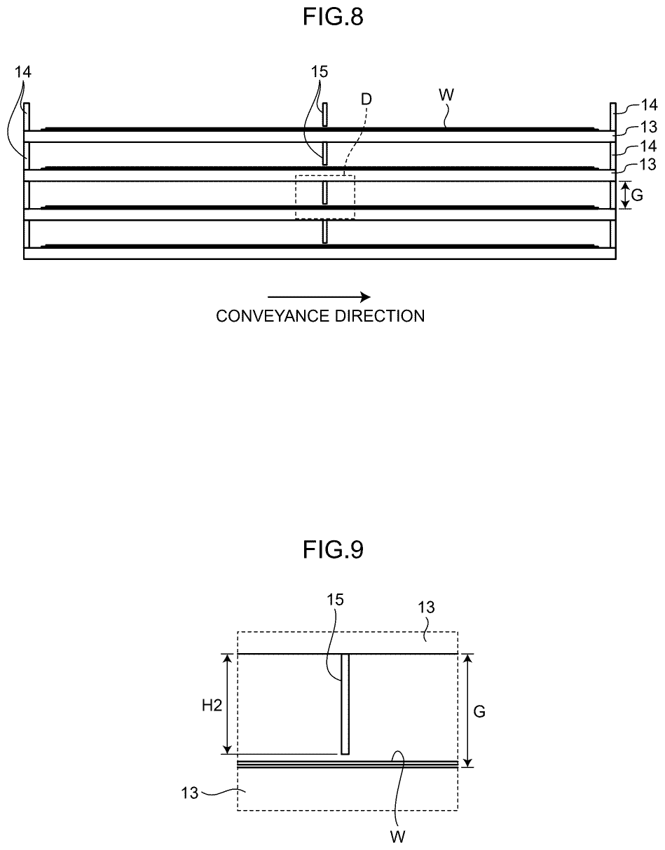

Therefore, in the continuous heating apparatus 1, the above problem is solved by devising a conveyance tray 13 that conveys the workpiece W. Hereinafter, a specific configuration of the conveyance tray 13 will be described with reference to FIGS. 4 to 9.

As illustrated in FIG. 4, the workpiece W is disposed on the conveyance tray 13. Further, the conveyance trays 13 are used in a state of being stacked in a plurality of stages (four stages in this case) in the up-down direction (Y direction in FIG. 1). The conveyance trays 13 stacked in a plurality of stages in this manner are conveyed by the conveyance mechanism 11 to simultaneously heat workpieces W. The number of stages of the conveyance trays 13 is not limited to that shown in FIG. 4, and may be three or less, or five or more.

A pair of front-rear straightening plates 14 are provided at both upstream and downstream ends of the conveyance tray 13 in the conveyance direction. The front-rear straightening plates 14 are for straightening hot air supplied in the heating chamber 112. Further, the front-rear straightening plates 14 are erected perpendicularly to the conveyance direction from the bottom of the conveyance tray 13.

As described above, by providing the front-rear straightening plates 14 at both ends of the conveyance tray 13, as indicated by the arrow A in FIG. 3, the flow direction of the hot air is restricted, and therefore, as shown in FIG. 2, the hot air travels straight from the blowing port 121 to the suction port 122 in a direction transverse to the conveyance direction so as to flow across the conveyance tray 13. As a result, as compared with the case where the conveyance tray 13 (see FIG. 3) without the front-rear straightening plates 14 is used, it is possible to heat the whole workpiece W by appropriately applying hot air to the workpiece W, and thus it is possible to suppress temperature unevenness.

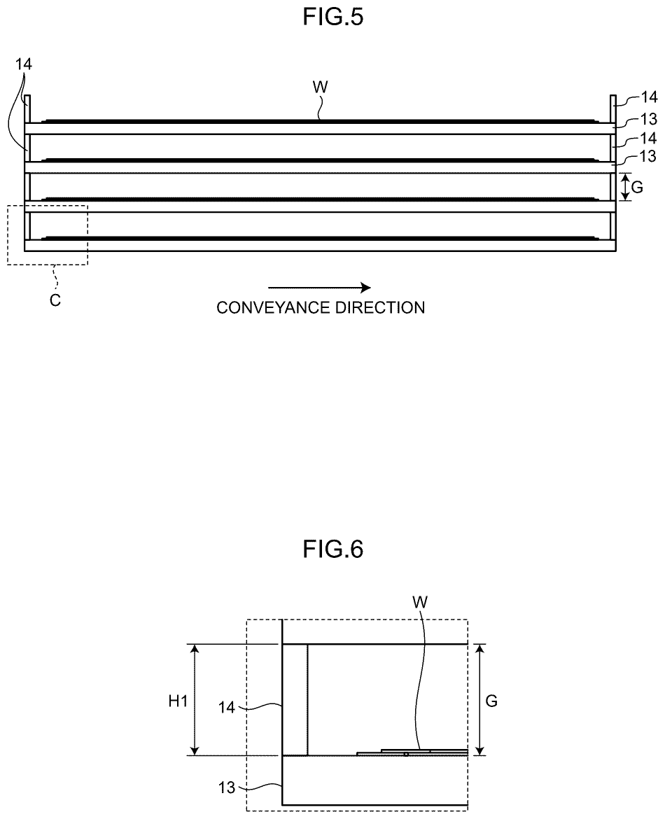

Here, the front-rear straightening plates 14 in the present embodiment also function as parts that supports the upper and lower conveyance trays 13. Therefore, as shown in FIG. 6, the height H1 of each of the front-rear straightening plates 14 in the present embodiment is the same as the gap G between the upper and lower conveyance trays 13.

However, the relationship between the height H1 of each of the front-rear straightening plates 14 and the gap G is not limited to that shown in FIG. 6. For example, when the gap G is “90 mm”, when the height H1 of each of the front-rear straightening plates 14 is equal to or greater than “60 mm”, that is, when the gap G is equal to or greater than “9”, the height H1 of each of the front-rear straightening plates 14 is equal to or greater than “6”, so that the straightening effect of the hot air can be exhibited and the thermal unevenness can be suppressed. When the height H1 of each of the front-rear straightening plates 14 is shorter than the gap G, the upper and lower conveyance trays 13 cannot be supported by the front-rear straightening plates 14, and therefore, it is preferable to support the upper and lower conveyance trays 13 using a separate jig or the like to secure a predetermined gap G.

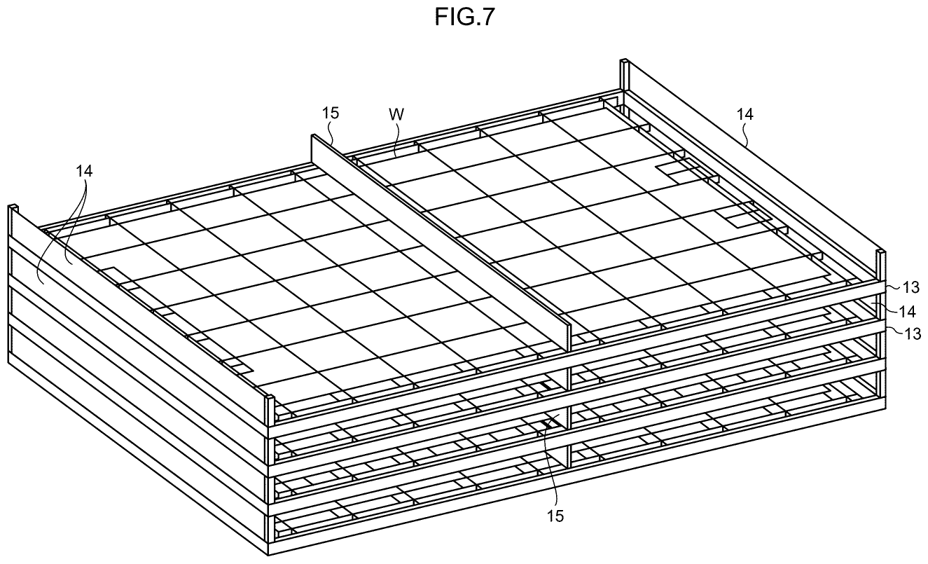

Further, as shown in FIGS. 7 to 9, for example, in addition to the front-rear straightening plates 14, a central straightening plate 15 may be provided in the conveyance tray 13. The central straightening plate 15 is for straightening the hot air supplied in the heating chamber 112, similarly to the front-rear straightening plates 14. The central straightening plate 15 is provided between the front-rear straightening plates 14 at the middle position of the conveyance tray 13 in the conveyance direction. Further, the central straightening plate 15 is erected perpendicularly to the conveyance direction of the conveyance tray 13 from the upper surface of the bottom of the conveyance tray 13. As shown in FIG. 9, another central straightening plate 15 is attached to the lower surface of the bottom of the conveyance tray 13.

As described above, by providing the central straightening plate 15 at the middle position of the conveyance tray 13, the flow direction in which the hot air ejected from the blowing port 121 is sucked into the adjacent suction port 122 as indicated by the arrow B in FIG. 3 is suppressed. Then, the hot air ejected from the blowing port 121 is sucked into the suction port 122 that opposes the conveyance tray 13. As a result, as compared with the case where the conveyance tray 113 without the central straightening plate 15 is used, it is possible to heat the whole workpiece W by appropriately applying hot air to the workpiece W, and thus it is possible to suppress temperature unevenness.

The central straightening plate 15 does not necessarily have to be arranged at the center of the conveyance tray 13 in the conveyance direction. As shown in FIG. 7, a plurality of central straightening plates 15 may be arranged in the conveyance tray 13. In the case where the workpiece W is heated using the conveyance tray 13, it has been found by simulation or the like that the warming of the central portion of the conveyance tray 13 is slower than the warming of the other portions of the conveyance tray 13.

Therefore, for example, by arranging the plurality of central straightening plates 15 obliquely with respect to the direction of the hot air, it is possible to heat the central portion of the central straightening plate 15 more quickly and uniformly throughout. Further, since the workpiece W is continuously conveyed, the time in which the central straightening plate 15 is in an ideal state (a state in which the flow of hot air is controlled by the central straightening plate 15) is also limited. Therefore, by arranging the plurality of central straightening plates 15 in the conveyance tray 13, it is possible to extend the time for controlling the flow of hot air by the central straightening plate 15, and thus it is possible to effectively suppress the temperature unevenness.

Here, the relationship between the height H2 of the central straightening plate 15 and the gap G is not limited to that shown in FIG. 9. For example, when the gap G is “90 mm”, the height H2 of the central straightening plate 15 is equal to or greater than “40 mm”, that is, when the gap G is equal to or greater than “9”, the height H2 of the central straightening plate 15 is equal to or greater than “4”, so that the flow straightening effect of the hot air can be exhibited and the thermal unevenness can be suppressed.

In FIG. 7 to FIG. 9, an example in which both the front-rear straightening plates 14 and the central straightening plate 15 are provided in the conveyance tray 13 has been described, but only the central straightening plate 15 may be provided in the conveyance tray 13. In this case, since the upper and lower conveyance trays 13 cannot be supported by the front-rear straightening plates 14, it is preferable to support the upper and lower conveyance trays 13 using a separate jig or the like to secure a predetermined gap G.

According to the continuous heating apparatus according to the embodiment described above, by arranging the front-rear straightening plates 14 at both ends of the conveyance tray 13, it is possible to suppress the suction of the hot air to the adjacent suction port 122, and thus it is possible to suppress the temperature unevenness.

Further, according to the continuous heating apparatus according to the embodiment, by disposing the central straightening plate 15 at the middle position of the conveyance tray 13, it is possible to control the direction of the hot air during continuous conveyance, it is possible to further effectively utilize the hot air, and thus it is possible to improve the productivity.

Further advantages and variations can be readily derived by one of ordinary skill in the art. Thus, the broader aspects of the invention are not limited to the specific details and representative embodiments presented and described above. Accordingly, various modifications may be made without departing from the spirit or scope of the general inventive concept as defined by the appended claims and their equivalents.

What is claimed is:

1. A continuous heating apparatus comprising:
a conveyance tray configured to place an object to be heated;
a conveying mechanism configured to convey the conveyance tray;
a blowing mechanism configured to blow hot air in a direction transverse to a conveyance direction of the conveyance tray; and
a pair of first straightening plates provided at upstream and downstream ends of the conveyance tray in the conveyance direction of the conveyance tray.

2. The continuous heating apparatus according to claim 1, further comprising a second straightening plate that is provided between the pair of first straightening plates at a middle position of the conveyance tray in the conveyance direction.
